(19) United States
(12) Patent Application Publication
(10) Pub. No.: US 2020/0116943 A1
(43) Pub. Date: Apr. 16, 2020

(54) Epoxy fiber attachment system and method

(71) Applicant: Axsun Technologies, Inc., Billerica, MA (US)

(72) Inventor: Carlos R. Melendez, Hudson, NH (US)

(21) Appl. No.: 16/653,529

(22) Filed: Oct. 15, 2019

Related U.S. Application Data
(60) Provisional application No. 62/745,680, filed on Oct. 15, 2018.

(51) Int. Cl. G02B 6/36

(52) U.S. Cl. CPC G02B 6/366

(57) ABSTRACT

A method and system for attaching an optical fiber to a bench. A mounting structure is attached to the bench and the proximal end of the optical fiber is epoxy bonded to the mounting structure.

### RELATED APPLICATIONS

This application claims the benefit under 35 USC 119(e) of U.S. Provisional Application No. 62/745,680, filed on Oct. 15, 2018, which is incorporated herein by reference in its entirety.

### BACKGROUND OF THE INVENTION

Integrated, hybrid micro-optical systems are typically housed within hermetic packages. One or more fiber pigtails will pass through fiber feedthroughs in sidewalls of the packages. The pigtails are then secured down onto a micro optical bench in the package. Other optical elements, such as lenses, fibers, micro-optical electro-mechanical systems (MOEMS) devices, and laser and semiconductor optical amplifier gain chips are also installed on the micro optical benches. In such systems, the beam diameters are typically less than one millimeter.

One approach to manufacturing these integrated micro-optical systems utilizes a combination of optical element mounting structures and pick-and-place style bonders. The basic technology is disclosed in U.S. Pat. Nos. 6,625,372, 6,941,631, 6,404,567, and 7,124,928, for example. Specifically, flip-chip bonders have been used in such systems. Further, the mounting structures may be designed to be susceptible to plastic deformation to enable active and/or passive alignment of the associated optical elements after the installation of the mounting structures on the bench.

### SUMMARY OF THE INVENTION

The present invention concerns a fiber attachment system and method. Rather than the typical solder attachment to the bench, an epoxy-based process is described.

In general, according to one aspect, the invention features a method for attaching an optical fiber to a bench. The method comprises attaching a mounting structure to the bench and epoxy bonding a proximal end of the optical fiber to the mounting structure.

In general, according to another aspect, the invention features a system for attaching an optical fiber to a bench. The system comprises a mounting structure attached to the bench and a proximal end of the optical fiber epoxy bonded to the mounting structure.

The above and other features of the invention including various novel details of construction and combinations of parts, and other advantages, will now be more particularly described with reference to the accompanying drawings and pointed out in the claims. It will be understood that the particular method and device embodying the invention are shown by way of illustration and not as a limitation of the invention. The principles and features of this invention may be employed in various and numerous embodiments without departing from the scope of the invention.

### BRIEF DESCRIPTION OF THE DRAWINGS

In the accompanying drawings, reference characters refer to the same parts throughout the different views. The drawings are not necessarily to scale; emphasis has instead been placed upon illustrating the principles of the invention. Of the drawings:

FIG. 1 is a schematic side cross sectional view showing a fiber optic device;

FIG. 2 is a schematic front view showing a fiber mounting structure of the fiber optic device; and

FIG. 3 is a flow diagram showing a method for installing an optical fiber in the fiber mounting structure.

### DETAILED DESCRIPTION OF THE PREFERRED EMBODIMENTS

The invention now will be described more fully hereinafter with reference to the accompanying drawings, in which illustrative embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art.

As used herein, the term “and/or” includes any and all combinations of one or more of the associated listed items. Further, the singular forms and the articles “a”, “an” and “the” are intended to include the plural forms as well, unless expressly stated otherwise. It will be further understood that the terms: includes, comprises, including and/or comprising, when used in this specification, specify the presence of stated features, integers, steps, operations, elements, and/or components, but do not preclude the presence or addition of one or more other features, integers, steps, operations, elements, components, and/or groups thereof. Further, it will be understood that when an element, including component or subsystem, is referred to and/or shown as being connected or coupled to another element, it can be directly connected or coupled to the other element or intervening elements may be present.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

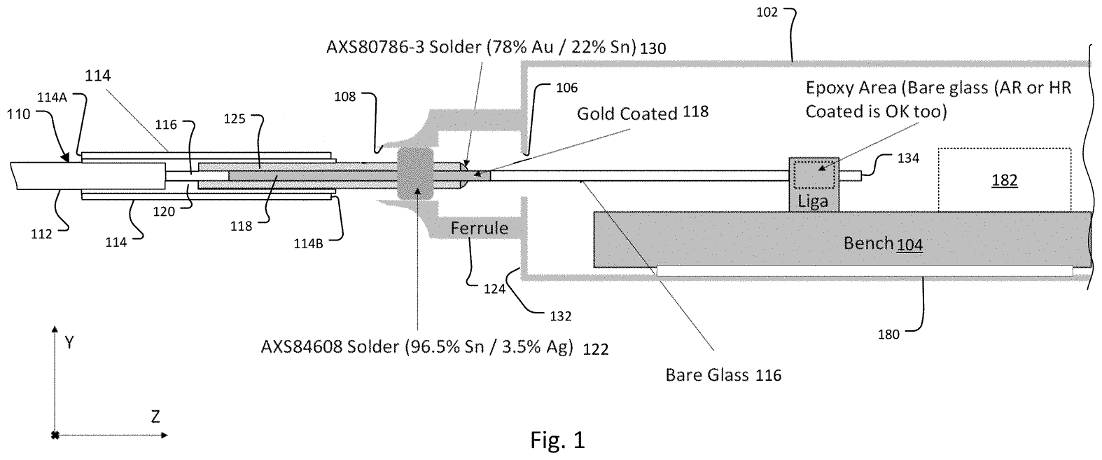

FIG. 1 is a schematic side cross-sectional view showing the system for epoxy fiber attachment.

In more detail, as is common, an optical bench 104 is installed within a hermetic package 102. Typically, an optical system 182, such as a tunable laser or optical spectrometry system, is fabricated on the bench 104 in the package 102.

The bench 104 is preferably a micro optical bench. As such, the bench 104 is typically less than 2 millimeters (mm) thick, in the y-axis direction. Its dimensions in the z-x plane are typically less than 30 mm by 20 mm.

Often a thermoelectric cooler 180 is located in the package 102, often installed between an underside of the bench 104 and an upper inner floor of the package 102.

The optical system 182 on the bench 104 receives optical signals from or generates optical signals for a larger system. Those optical signals are provided to the optical system 182 on the bench 104 or generated and sent out of the optical system 182 using one or more optical fibers 110.

Typically, the optical fibers 110 are single mode optical fibers. But the present invention and fiber attachment process could be easily applied to larger, multimode fibers. A typical single-mode optical fiber has a core diameter between 8 and 10.5 μm and a cladding diameter of 125 μm.

In general, the optical fiber 110 is coupled to the optical system on the bench 104 by inserting the end 134 of the optical fiber 110 through the port 108 of a ferrule 124 on a side wall 132 of the package 102. The optical fiber 110 then extends through a fiber feedthrough 106 in the package 102 and then is secured to the bench 104. In the present invention, the end 134 of the optical fiber 110 is secured using epoxy.

The typical optical fiber has a fiber jacket 112 that surrounds a center glass core 116. For the attachment, this fiber jacket 112 is stripped from the glass core 116 to leave a bare glass length of fiber. Often, this bare glass has a length of between 2 and 8 mm, preferably about 4.00 mm. An inner tube 125, such as a stainless steel tube (with an inner diameter of between 0.10 mm and 0.25 mm or preferably about 0.175 mm and an outer diameter of less than 1 mm or about 0.699 mm is inserted over the bare glass core 116 along with a larger obertube 114. The obertube 114 has an inner diameter of about 1-2 mm or preferably about 1.067 mm and an outer diameter of 1 mm to 2 mm or preferably about 1.270 mm. Thus, the obertube distal end 114A is wide enough to accommodate the fiber jacket 112. The proximal end 114-2 has an inner bore that is sized to only accommodate inner tube 125. In this way, the obertube bridges the gap between the fiber jacket 112 and the inner tube 125. A layer of inter-tube epoxy 120 bonds the fiber jacket 112, the inner tube 125 and the obertube 114 to each other.

Preferably, the bare glass fiber 116 is gold coated 118 in the region that is within the innertube 125. The gold fiber coating is especially required at the proximal end of the inner tube 125. Here the inner tube 125 meets the fiber so a solder bond 130 can be created. Currently, 78% gold/22% tine solder is used. In other cases, in order to reduce the fiber cost and simplify the process, a glass-solder can be used, which completely eliminates the need for gold on the fiber.

The optical fiber 116 and the proximal end of the innertube 125 extend into the mouth 108 of the ferrule 124 on the side wall 132 of the package 102. The proximal end of the innertube 125 terminates within this ferrule and the bare glass optical fiber 116 extends through the fiber feedthrough 106 in the side wall 132 of the package 102. The end facet of 134 of the glass optical fiber 116 is then secured down onto the bench 104 using a fiber mounting structure 104. According to the invention, the proximal end of the optical fiber near the fiber's end facet 134 is secured to the fiber mounting structure 104 using epoxy.

The current embodiment uses an epoxy that is ultraviolet and heat curable with low shrinkage, low creep and good adhesion. Currently, OptoCast 3410 epoxy is being used.

The fiber extends past the mounting structure 104 by approximately between 0.100 mm to 1.000 mm.

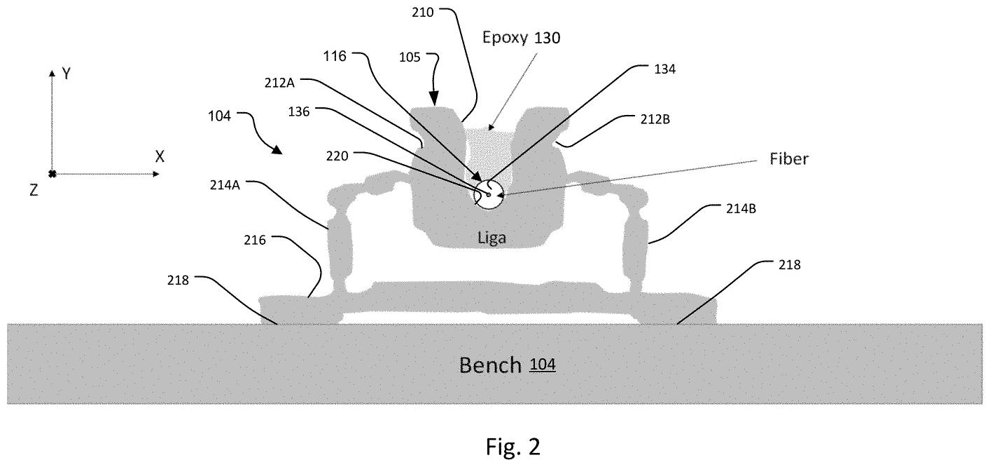

FIG. 2 shows the fiber mounting structure 104 holding the optical fiber 116 and the center core 136 of the glass fiber 116.

In more detail, the fiber mounting structure 104 comprises a head 105 that includes a U-shaped trough 210. The proximal end of the fiber 116 sits at the bottom 220 of this trough 210.

In the illustrated embodiment, the fiber mounting structure includes features that allow for the post installation alignment. Specifically, the head 105 includes two handle cutouts 212A and 212B on either side of the head 105. This allows an alignment system to grab the head 105 to thus position the facet at the fiber end 134 relative to the optical system on the bench 104. Two flexures 214A, 214B connect the head 105 in the fashion of respective legs to the mounting structure's base 216. In the typical implementation, the base 216 is solder bonded 218 to upper surface of the bench 104. This allows the head to be moved during the installation process in which the flexors 214 A, 214 B are plastically deformed in order to align the fiber end face 132 and specifically the core 136 to the optical system 182.

According to the invention, the proximal end 134 of the fiber 116 is epoxy bonded into the trough 210 of the head 105 of the mounting structure 104.

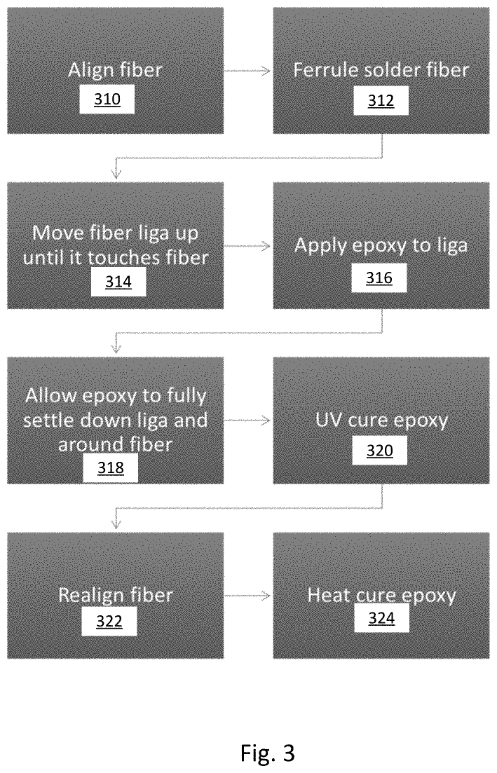

FIG. 3 is a flow diagram showing the epoxy fiber attachment method of the present invention.

Specifically, in the first step 310, the fiber end facet 134 is aligned to the optical system 182 on the bench 104. Typically, this is an axial alignment in which the end 134 of the fiber is positioned in the z-axis direction relative to the optical system 182. The ferrule is then soldered to the innertube 125 with the solder 122, which is preferably 96.5% tin and 3.5% gold, in step 312.

In the next step 314, an alignment system engages the handles 212A, 212 B of the head 105 of the alignment structure 104, also known as a “liga”, and pulls the alignment structure up, deforming the flexures 214A, 214B until the proximal end of the fiber 116 sits at the bottom 220 of the trough 210.

At this point, epoxy 130 is applied into the trough 210 to surround the proximal end of the fiber 116 in step 316. Preferably, the epoxy is allowed to seep around the fiber for at least several minutes and typically more than 10 minutes. Then, the epoxy is preferably cured by exposing it to ultraviolet light in step 320.

The end facet core 136 of the optical fiber is then finally aligned to the optical system 182 on the bench 104 in step 322. Here again, the alignment system engages the head 105 of the alignment structure at the cutout handles 212 A, 212 B to plastically deform the flexors 214A, 214B in this fine alignment process. Then, the epoxy 130 is heat cured to finish the process in step 324.

While this invention has been particularly shown and described with references to preferred embodiments thereof, it will be understood by those skilled in the art that various changes in form and details may be made therein without departing from the scope of the invention encompassed by the appended claims.

What is claimed is:

1. A method for attaching an optical fiber to a bench, comprising:
attaching a mounting structure to the bench; and
epoxy bonding a proximal end of the optical fiber to the mounting structure.

2. The method of claim 1, further comprising axially aligning the optical fiber and bonding the fiber to a ferrule of a package containing the bench.

3. The method of claim 1, further comprising:
moving the mounting structure into engagement with the optical fiber; and
applying epoxy between the mounting structure and the optical fiber.

4. The method of claim 1, further comprising
applying epoxy between the mounting structure and the optical fiber; and
UV curing the epoxy; and
then aligning the optical fiber to an optical system on the bench.

5. The method of claim 3, further comprising after alignment, heat curing the epoxy.

6. A system for attaching an optical fiber to a bench, comprising:
a mounting structure attached to the bench; and
a proximal end of the optical fiber epoxy bonded to the mounting structure.

7. A system as claimed in claim 6, further comprising a package containing the bench, wherein the optical fiber extends through a ferrule of the package.

8. A system as claimed in claim 7, wherein the optical fiber is soldered in the ferrule.

9. A system as claimed in claim 6, further comprising an inner tube surrounding the optical fiber, the optical fiber being bonded to the inner tube.

10. A system as claimed in claim 9, further comprising an obertube surrounding the inner tube.

11. A system as claimed in claim 10, further comprising the obertube being bonded to a jacket of the optical fiber.

12. A system as claimed in claim 6, wherein the mounting structure includes one or more flexors for plastic deformation alignment.
